(19) United States
(12) Patent Application Publication
(10) Pub. No.: US 2015/0321371 A1
(43) Pub. Date: Nov. 12, 2015

(54) SLICER

(71) Applicant: Inauen Group AG, Herisau (CH)

(72) Inventor: Ralf Peter Mueller, Kempten (DE)

(21) Appl. No.: 14/705,666

(22) Filed: May 6, 2015

(30) Foreign Application Priority Data
May 7, 2014 (DE) 102014106353.8

(51) Int. Cl. B26D 7/06; B26D 3/16

(52) U.S. Cl. CPC B26D 7/0616; B26D 3/161

(57) ABSTRACT

Slicers for cutting food such as sausage, cheese or meat, for example, into slices. Such slicers, and processes related thereto, may simultaneously slice at least two stick-shaped pieces of food by a cutting blade. The feeding of the food that is sliced may be further improved thereby. An exemplary feed unit (9) for feeding food (10) to a cutting blade (7) includes at least one gripper carriage (20) including a gripper receiving beam (22) and at least one movable gripper (21). This gripper (21) may be operated by a stationary drive, and the mechanical work for seizing can be transferred to the grippers (21) via guides or further drive structure.

This application claims benefit of priority to prior German national application no. DE102014106353.8 filed on May 7, 2014, and the entirety of this German application no. DE102014106353.8 is expressly incorporated herein by reference in its entirety and as to all its parts, for all intents and purposes, as if identically set forth in full herein.

The present disclosure relates to slicers for cutting food, such as sausage, cheese or meat, for example, into slices, in particular for simultaneously slicing at least two stick-shaped pieces of food by means of a cutting blade.

Stick-shaped food is cut into slices or is sliced, respectively, by means of powerful cutting machines, also called slicers, wherein at least one food stick is fed to a cutting blade.

EP0713753B1, for instance, shows a quick cutting machine comprising a cutting station and a drive, which drives the knife along a predetermined cutting path, a device for supporting the food sticks, which are to be cut, wherein each of the food sticks can be fed by means of its own feed drive in response to simultaneously feeding two food sticks. The feed drives move the food sticks along the parallel feed paths vertically to the cutting path of the knife, wherein knife and feed are placed at an angle to the table plane of the cutting machine. The food sticks are inserted into the cutting machine horizontally and are lifted at an angle by grippers upstream of the cutting station at the end, which is located at a distance from the cutting station, for a cutting position.

According to EP2543484A1, the gripper or product holder is provided with a guide device, which guides the product holder on two sides, which are vertically spaced apart from the conveying direction. According to EP 2543485 A1, the guide device encompasses at least one carriage, which can be moved along the conveying direction, on which the product holder is arranged. For this purpose, the carriage is coupled to a linear drive, in particular an electromagnetic linear motor.

At least one actuator of the linear drive is furthermore coupled to the carriage in a contact-free manner and is guided in a cylindrical hollow space of the guide device along the conveying direction. Carriage and/or actuator consist of magnetizable material. The actuator divides the hollow space into sections, on at least one of which a hydraulic fluid can act, so as to move the actuator. The encapsulation, analogous to ball screws, which are also used, can be problematic hereby.

Further problems or application limits can result from the limited length and speed in the case of ball screws in response to a quick return stroke.

WO02/30735A1 discloses a device for simultaneously slicing at least two food products, in the case of which a slicing of slices of the same thickness as well as a slicing of portions comprising a uniform weight is to be attainable in spite of product differences, which are at hand. For this purpose, the product holders encompass a common base drive for moving synchronously, wherein an additional movement can be superimposed positively or negatively in the case of at least one product holder. This is attained by means of an auxiliary drive. An additional lifting of the product for changing the slice thickness is created by means of the auxiliary drive, if this is necessary based on the determined stack weights.

Another device of this type for slicing food follows from WO2005/037501 A1, in the case of which food sticks are transported to the blade on a conveying means. The rear ends of the food sticks are at least temporarily in contact with a means, for example a gripper, which does not have its own drive during the contact. This is to ensure that the food sticks are tensioned sufficiently firmly on the conveying means to the end and thus stay sliceable.

The present disclosure relates to the task of developing a slicer for cutting food, such as sausage, cheese or meat, for example, into slices, in particular for simultaneously slicing at least two stick-shaped pieces of food, which is provided with a further improved feed of the food, which is to be sliced.

Such cutting machines, slicers, may include a lifting and conveying device for the food, that is to be sliced, to the cutting blade, a feed unit for the food, which is to be sliced, a stacking table for the food, which was sliced, as well as a control unit.

According to the present disclosure, an exemplary feed unit encompasses at least one gripper carriage including a gripper receiving beam, on which at least one or any number of grippers are guided. The feed unit furthermore includes a linear guide, which is embodied by means of guide bars, e.g., on which the gripper carriage is arranged, furthermore a servo drive and means for moving the gripper carriage. The gripper or the grippers are operated by a stationary drive, wherein the mechanical work of gripping is transferred via the guide bars or further drive structure.

A significant feature of an exemplary slicer according to the present disclosure is that the drive for operating the grippers does not move along on the gripper carriage, but is accommodated in the machine housing in a stationary manner and can thus be carried out electrically as well as pneumatically. Otherwise, in the event of moving along on the gripper carriage, an unhygienic and interference-prone movable energy chain would be necessary.

Advantageous further developments are disclosed within the present disclosure, which includes the appended drawings and claims.

The gripper carriage is thus guided on the guide bars and is arranged so as to be linearly movable, wherein at least one guide bar can be rotated simultaneously about its own longitudinal axis.

A gripper receiving beam of the gripper carriage is guided in particular on the other guide bar and may be moved along the feed axis by means of a toothed belt overdrive. The toothed belt overdrive includes two wheels, between which a toothed belt runs back and forth, wherein the toothed belt is simultaneously coupled to the gripper carriage, so that it is entrained in response to a movement of the toothed belt.

Provision may also be made for two independent gripper carriages, that each include a toothed belt.

Preferably, the gripper receiving beam may be arranged vertically to the feed axis of the food and may be provided with a linear element guided therein. A push rod, the other end of which is articulated in a rotationally movable manner on the guide bar, is arranged on the end of the linear element, that is located closer to the guide bar.

A transverse movement of the linear element to the feed axis takes place by rotation of the guide bar. The linear element forms the interface for transferring the drive work to the grippers. The grippers may be removed for cleaning purposes and may be fastened securely to the gripper receiving beam via a quick fastener. The transfer of the drive force for the gripping movement is to also be ensured thereby. In a preferred version, pockets, which then transfer the force to the lever kinematics of the gripper in a positive manner, are incorporated into the linear element. In the case of this interface, the transfer of the drive force from the sides of the pockets to a roller located on a pivot lever, has proven to be particularly advantageous, because of low friction. The reverse arrangement of a roller on the linear element and an entraining surface on a pivot lever or a link piece is also efficient.

The force for operating the claws is preferably transferred by means of a slider crank by the pivot lever located on the gripper. Instead of the pivot lever, a slide gate or similar mechanical elements are also possible, which divert the operating force in the axial direction of the gripper. The operation of the individual claws takes place analogous to the existing, for example pneumatically operated grippers via levers, cranks or tooth segment toothed rack combinations.

An exemplary toothed belt overdrive according to the present disclosure includes a drive wheel and a tensioning roller 34, between which a toothed belt runs back and forth. Both ends of the toothed belt are connected to gripper carriages. This allows for the use of open toothed belt. When using a continuous belt, the connection to the gripper carriage may be made in the same manner.

The toothed belt may preferably be a belt including steel cords that are embedded in an elastic base belt body of an elastomer material, which is suitable for use in food.

An exemplary slicer according to the present disclosure is characterized by a high measure of hygiene and longevity of the product feed.

More details are explained in the following discussion via an exemplary version depicted in the appended drawing sheets. In the drawings:

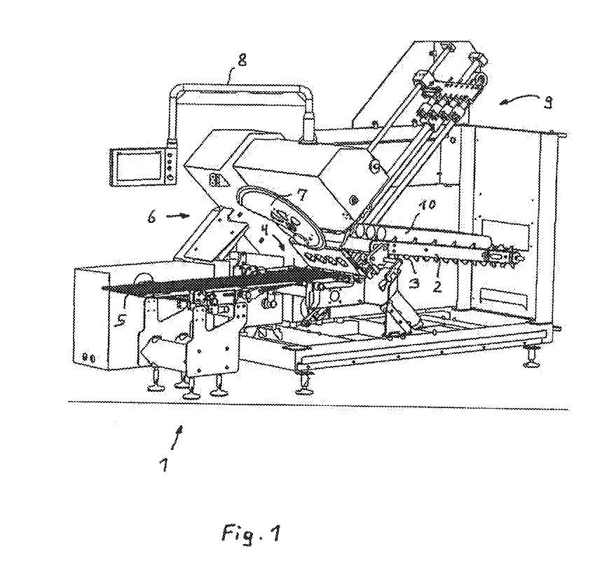

FIG. 1—depicts a slicer according to the present disclosure;

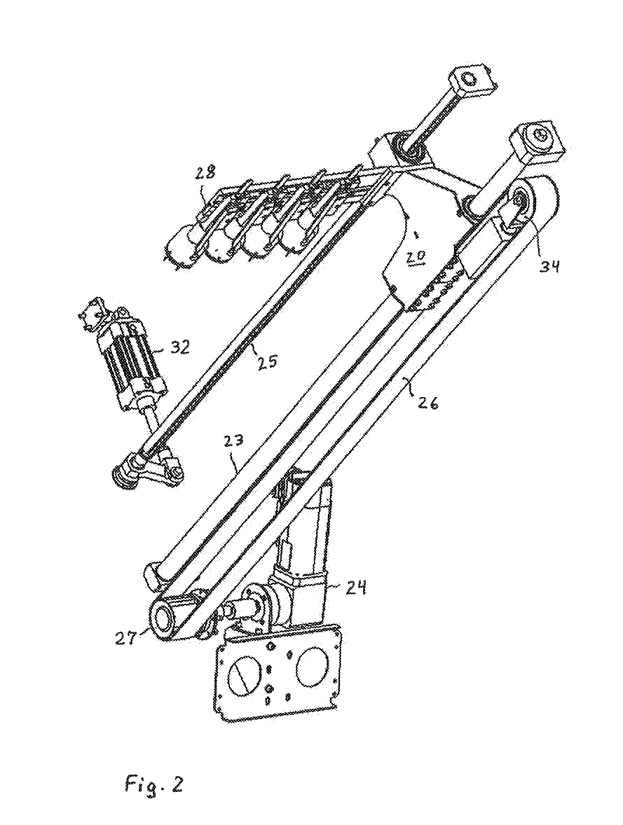

FIG. 2—depicts a feed unit of the slicer according to FIG. 1;

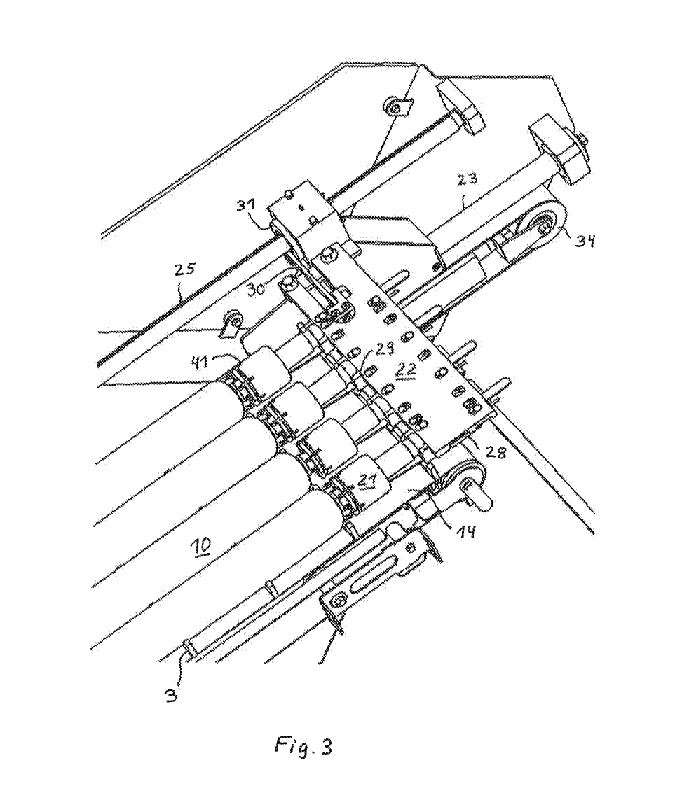

FIG. 3—depicts a gripper accommodation of the feed unit according to FIG. 2;

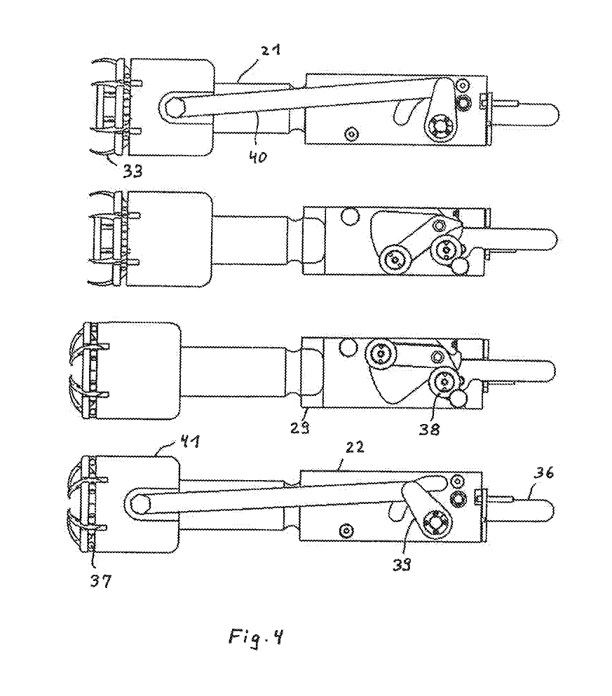

FIG. 4—depicts a gripper according to the present disclosure;

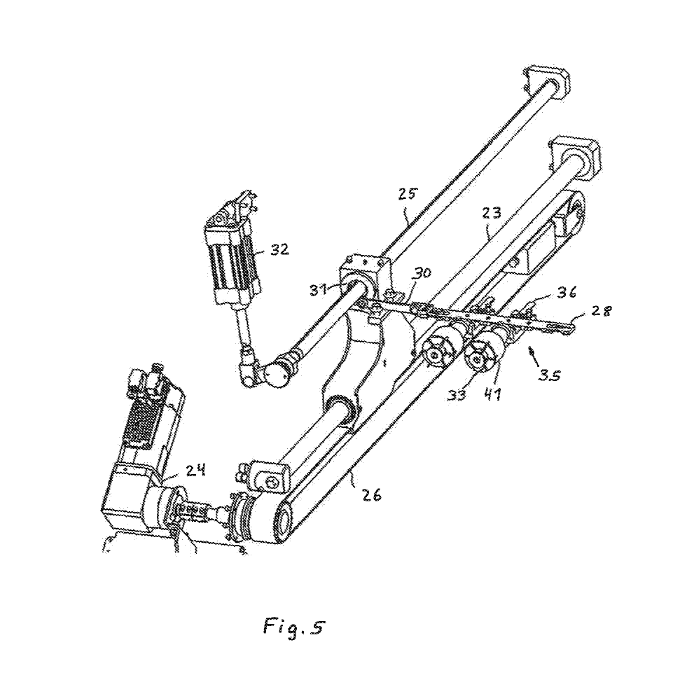

FIG. 5—depicts the gripper accommodation according to FIG. 4 in a different illustration; and,

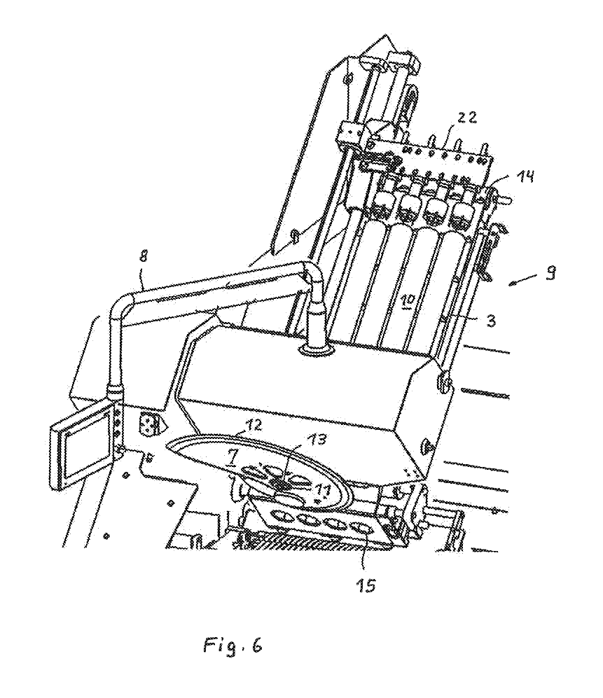

FIG. 6—depicts the slicer according to FIG. 1.

Any reference in this specification via terminology such as “one version,” “a version,” “a variant,” “one variant,” “one embodiment,” and “an embodiment,” should be understood to mean that a particular feature, structure, or characteristic described in connection with the version, variant, or embodiment is included in at least one such version, variant, or embodiment of the disclosure. The appearances of phrases “in one/a version,” “in one/a variant,” “in one/a embodiment”, and the like in various places in the specification are not necessarily all referring to the same variant, version, or embodiment, nor are separate or alternative versions, variants or embodiments necessarily mutually exclusive of other possible versions, variants, or embodiments. Moreover, various features are described which may be exhibited by some versions, variants, or embodiments and not by others. Similarly, various requirements are described, and some may be requirements for some versions, variants, or embodiments but not others. Furthermore, if the specification states a component or feature “may”, “can”, “could”, or “might” be included or have a characteristic, via such terminology it should be understood that such particular component or feature is not always necessarily required to be included or have the characteristic. Additionally, as used throughout this specification, the terms ‘a’, ‘an’, ‘at least’ do not denote a limitation of quantity, but rather denote the presence of at least one of the referenced item, and any usage of the term ‘a plurality’ denotes the presence of more than one referenced items.

A slice cutting machine, as in exemplary FIG. 1, for slicing stick-shaped food 10 into slices, a so-called slicer 1, includes a feed device 2 for the food 10, which is to be cut, e.g. sausage or cheese in the form or sticks or bars to a cutting device 6 including a cutting blade 7, a lifting and conveying device 3, a stacking table 4 for the sliced food (portions) as well as a conveyor belt 5 for removing the sliced food 10 to a non-illustrated vacuum packaging device.

It furthermore includes a control unit 8 for the slicer 1 and a feed unit 9 for the food 10, which is to be sliced.

The cutting blade 7 (FIG. 6) may be fixed in the cutting device 6 by means of screws or quick-clamp device on an accommodation of a rotor 13, which is connected to a drive motor. A feed plane for feeding the food 10, which is to be cut, to which the conveyor belt 5 for removing stacks of slices of the cut food 10 to the stacking table 4 connects below said feed plane, is assigned to the cutting blade 7.

The cutting device 6 and the cutting blade 7 are arranged so as to be inclined in the direction of the stacking table 4, which provides for an improved cutting line and which saves space or which allows for longer food sticks in the slicer 1, respectively.

The drive motor sets the cutting blade 7 into rotation about the axis of the rotor 13. For making the cut, the block or stick-shaped food 10 is fed to the cutting blade 7 with a feed, which corresponds to the desired slice thickness.

The cutting blade 7 is in particular a sickle blade, as it is disclosed in DE202013101903U1, for example. On the circumference, it is provided with a spiraled cutting edge 12, that points radially outwards and which encompasses a recess. It is furthermore provided with a centrical accommodating hole 11 and can thus be directly and releasably assembled on the cutting rotor 13.

The cutting blade 7 is embodied with the cutting edge 12, that points outwards in an at least partially ring-shaped manner, with the recess and with a radius expansion of the cutting edge 12, wherein the center of area is located outside of the axis of rotation, which does not require a separate positioning for carrying out a cut.

The cutting blade 7 encompasses an accommodating hole 4 including a diameter of approx. 100 mm, that is surrounded by two spaced-apart partial circles including a larger diameter.

Fastening holes on the inner partial circle serve to releasably fasten the cutting blade 7 to the accommodation of the rotor 13.

From an assembly area, the stick-shaped food 10 reaches to a continuous conveyor belt 14 of the lifting and conveying device 2, that is provided with accommodating profiles 3 (FIGS. 1, 6). The accommodating profiles 3 encompass a mating contour to the food stick and ensure a parallel feeding of the food sticks and thus the same cutting parameters of the food sticks fed in one clamping.

The food 10 may be lifted to approximately the height of the cutting blade 7 by means of the lifting and conveying device 3 and is guided through openings 15, that fit the shape, in an intermediate wall.

The ends of the food 10, that face away from the cutting blade 7, are additionally pivoted upwards about a virtual pivot point, in common with the cutting blade 7, until the ends or their longitudinal axis, respectively, form approximately a right angle to the cutting plane of the cutting blade 7.

This makes it possible for product holders or grippers 21 of the feed unit 9 to seize the remote ends of the food sticks and to ensure an even feeding to the cutting device 6 in longitudinal direction (FIG. 3).

The feed unit 9 furthermore includes a gripper carriage 20 including a gripper receiving beam 22, on which the grippers 21 are guided, two guide bars 23 and 25, which are arranged parallel to one another, a servo drive 24 and elements for moving the gripper carriage 20 (FIGS. 2, 3). The gripper carriage 20 is guided on the guide bars 23 and 25 so as to be linearly movable, wherein the guide bar 25 can simultaneously also carry out a rotation about its own longitudinal axis.

The gripper carriage 20 (FIG. 2) is guided with the gripper receiving beam 22 on/at the guide bar 23, which is round in the example, and is moved precisely along the feed axis by means of a toothed belt overdrive via the servo drive 24.

The toothed belt overdrive includes a drive wheel 27 including teeth and a tensioning roller 34, which can also be embodied without toothing, between which a toothed belt 26 runs back and forth. The toothed belt 26 is coupled to the gripper carriage 20 below the guide bar 23 (FIG. 2). The coupling allows for the use of open toothed belts, which are also identified as yard goods.

A belt including steel cords, that are embedded into an elastic basic belt body of an elastomer material, which is suitable for use in food, is preferably used as toothed belt 26. Due to a special version, the steel pull ropes are sealed completely with the belt material, which applies for the belt sides as well as for the tooth bases. The use of the toothed belt 26 is very hygienic, because the strands, into which water and dirt could permeate, are sealed completely with plastic. In addition, such a toothed belt 26 is very durable, because a corrosion of the strands does not occur and the realizable feed movement is constant and highly accurate due to the high stiffness of the steel strands.

Due to manufacturing, the pull ropes in the case of common toothed belts, in contrast, are exposed on the belt sides as well as in the tooth base, where they rest on the grooves when being sealed.

The stiffness, which is lower as compared to conventional toothed belts including steel strands, may be compensated by the corresponding dimensioning of the toothed belt 26 with regard to width and partition.

The grippers 21 may be coupled to the gripper receiving beam 22 of the gripper carriage 20 via a quick fastener 35, so that they may be operated centrally from the stationary part of the slicer 1. They can be controlled accurately via a common mechanism.

The coupling of each gripper 21 in each case takes place in pockets 29 on the gripper receiving beam 22 and by means of a locking lever 36. The gripper receiving beam 22 is arranged vertically to the feed axis of the food 10 and is provided with a linear element 28 guided therein. A push rod 30 is arranged in a rotatably movable manner on the end of the linear element 28 located closer to the guide bar 25. The other end of the push rod 30 is articulated on a rotationally-fixed ring 31 of the guide bar 25 in a rotatably movable manner. A rotation or a torque, receptively, of the guide bar 25, triggered by a servo motor 32, is thus converted into a linear movement of the linear element 28.

This linear movement is transferred to all of the coupled grippers 32 similarly and simultaneously via interfaces and controls the gripper mechanism for operating the gripper claws 33.

In FIG. 4, grippers 21 are illustrated in an exemplary manner with open and closed gripper claws 33. The gripper mechanism includes a pivot lever 38, that is arranged on a roller 39 and which is connected to a slider crank 40. The other end of the slider crank 40 corresponds to the movement device of the gripper claws 33.

The pivot lever 38 is pivoted in the direction of a gripper head 41 via linear movement of the linear element 28 for closing the gripper claws 33, and the slider crank 40 thereby pushes the gripper head 41, which is guided in a groove, forwards. The gripper claws 33 are thereby pivoted inwards about their bearing point (cylinder pins 37) in the direction of the longitudinal axis of the food stick and engage therewith.

The slider crank 40 is pulled in the opposite direction by means of a linear movement of the linear element 28 for opening the gripper claws 33 or for letting go of the food stick, respectively.

As compared to currently common pneumatic drives, the design is simplified significantly and is cost-efficient. Common plug-in connections, the tangle of pneumatic hoses as well as a grease lubrication of the pneumatic cylinders is no longer necessary. This also serves for an improved hygiene.

A purely electrical drive of the slicer 1 according to the present disclosure makes it possible to operate without compressed air.

In closing, it should be noted that the above description is intended to illustrate rather than limit the invention, and that readers skilled in the technological art shall be capable of designing alternative embodiments without departing from the protected scope of invention as set forth by the appended claims. As equivalent elements can be substituted for elements employed in claimed invention so as to obtain substantially the same results in substantially the same way, the protected scope of the present invention is defined by the appended claims, including known equivalents and unforeseeable equivalents at the time of filing of this application. Furthermore, in the claims, the verb ‘comprise’ and its conjugations do not exclude the presence of elements or steps other than those listed in any claim or the specification as a whole. The singular reference of an element does not necessarily exclude the plural reference of such elements and vice-versa. The mere fact that certain measures are recited in mutually different dependent claims does not necessarily indicate that a combination of these measures cannot be used to advantage.

### LIST OF REFERENCE LABELS

1 slicer
2 lifting and conveying device
3 accommodating profile
4 stacking table
5 conveyor belt
6 cutting device
7 cutting blade
8 control unit
9 feed unit
10 food
11 accommodating hole
12 cutting edge
13 rotor
14 continuous conveyor belt
15 opening
20 gripper carriage
21 gripper
22 gripper receiving beam
23 guide bar
24 servo drive
25 guide bar
26 toothed belt
27 toothed wheel
28 linear element
29 pocket
30 push rod
31 ring
32 servo motor
33 gripper claw
34 tensioning or deflection roller
35 quick fastener
36 locking lever
37 cylinder pin
38 pivot lever
39 roller
40 slider crank
41 gripper head

What is claimed is:

1. A slicer for cutting food, such as sausage, cheese or meat, for example, into slices, in particular for simultaneously slicing at least two stick-shaped pieces of food by means of a cutting blade, comprising a feeding of the food, which is to be sliced, to the cutting blade, characterized in that a feed unit for feeding the food to the cutting blade comprises at least one gripper carriage comprising a gripper receiving beam and at least one movable gripper, wherein the at least one gripper can be operated by means of a stationary drive, and wherein the mechanical work for seizing can be transferred to the grippers via guides or further drive means.

2. The slicer according to claim 1, characterized in that the gripper carriage is guided on a linear guide, preferably in the form of guide bars and is arranged so as to be linearly movable, wherein the guide bar can simultaneously be rotated parallel to its longitudinal axis.

3. The slicer according to claim 1, characterized in that the gripper carriage comprising the gripper receiving beam is guided on the guide bar and can be moved along the feed axis by means of a toothed belt overdrive.

4. The slicer according to claim 1, characterized in that the toothed belt drive comprises a toothed wheel and a tensioning or deflection roller, between which a toothed belt runs back and forth, and that the toothed belt is coupled to the gripper carriage, wherein the toothed belt is provided with pull ropes, which are sealed on all sides by means of a plastic material of the toothed belt.

5. The slicer according to claim 1, characterized in that the gripper receiving beam is arranged vertically to the feed axis of the food and is provided with a linear element guided therein, and that a push rod is arranged in a rotatably movable manner on the end of the linear element located closer to the guide bar with the other end of said push rod being articulated on the guide bar in a rotationally movable manner.

6. The slicer according to claim 1, characterized in that the gripper is provided with a slider crank, the ends of which correspond to a movement device of the gripper claws and the linear element.

7. The slicer according to claim 1, characterized in that one end of the slide crank is articulated on a gripper head of the gripper in a rotationally movable manner, wherein the gripper head is arranged so as to be movable in the direction of the longitudinal axis of the gripper.

8. The slicer according to claim 1, characterized in that the stationary drive for operating the gripper claws is carried out by means of pneumatic cylinder or electric motor.

9. A slicer for cutting food, such as sausage, cheese or meat, for example, into slices, in particular for simultaneously slicing at least two stick-shaped pieces of food by means of a cutting blade, comprising a feeding of the food, which is to be sliced, to the cutting blade comprising at least one feed unit, which moves at least one gripper carriage along the feed axis by means of a toothed belt drive, characterized in that the toothed belt is provided with pull ropes, which are sealed on all sides by means of a plastic material of the toothed belt.

10. The slicer according to claim 9, characterized in that the toothed belt overdrive comprises a toothed wheel and a tensioning roller or deflecting roller, respectively, between which the toothed belt runs back and forth.

11. The slicer according to claim 9, characterized in that the toothed belt (26) can be coupled to the gripper carriage and the toothed belt is provided with steel cords, which are embedded in an elastic base belt body of an elastomer material, which is suitable for use in food.

12. The slicer according to claim 9, characterized in that the feed unit comprises a gripper carriage comprising a gripper receiving beam, on which grippers are guided, a linear guide, in particular two guide rods, a servo drive and means for moving the gripper carriage.

13. The slicer according to claim 9, characterized in that the gripper carriage is guided on the guide bars and is arranged so as to be linearly movable, wherein the guide bar can be rotated simultaneously about its own longitudinal axis.

14. The slicer according to claim 9, characterized in that the gripper receiving beam is arranged vertically to the feed axis of the food and is provided with a linear element guided therein, and that a push rod is arranged in a rotatably movable manner on the end of the linear element located closer to the guide bar with the other end of said push rod being articulated on the guide bar in a rotationally movable manner.

15. The slicer according to claim 9, characterized in that the gripper is provided with a slider crank, the ends of which correspond to a movement device of the gripper claws and the linear element.

16. The slicer according to claim 9, characterized in that one end of the slide crank is articulated on a gripper head of the gripper in a rotationally movable manner, wherein the gripper head is arranged so as to be movable in the direction of the longitudinal axis of the gripper.

17. A method for cutting food, such as sausage, cheese or meat, for example, into slices, in particular for simultaneously slicing at least two stick-shaped pieces of food by means of a cutting blade of a cutting machine, comprising a seizing and feeding of the food, which is to be sliced, to the cutting blade, characterized in that the feeding of the food to the cutting blade takes place by means of a stationary drive, wherein the mechanical work for seizing is transferred to gripper via guides or further drive means.
